(19) United States
(12) Patent Application Publication
(10) Pub. No.: US 2019/0338836 A1
(43) Pub. Date: Nov. 7, 2019

(54) PRESSURE ACTIVATED METALLIC BAND PISTON SEAL

(71) Applicant: BorgWarner Inc., Auburn Hills, MI (US)

(72) Inventors: Jeremy BENN, Auburn, NY (US); Seongdo HONG, Ithaca, NY (US)

(21) Appl. No.: 16/476,600

(22) PCT Filed: Jan. 9, 2017
(86) PCT No.: PCT/US2017/012717

§ 371 Date: Jul. 9, 2019

(51) Int. Cl. F16H 7/08; F16J 9/08

(52) U.S. Cl. CPC F16H 7/0834; F16H 7/0848; F16J 9/08; F16H 2007/0859; F16H 2007/0812; F16H 2007/0851; F16H 2007/0806

(57) ABSTRACT

This invention pertains to the field of hydraulic tensioners. A hydraulic tensioner of this invention includes a tensioner body having a bore in fluid communication with a source of pressurized fluid through an inlet, a hollow piston slidably received within the bore and having an outer diameter, a hydraulic pressure chamber defined by the hollow piston and the bore of the tensioner body, a piston spring received within the hydraulic pressure chamber for biasing the piston away from the inlet, and a metallic band surrounding the outer diameter of the piston. The metallic band forms a seal between an outer surface of the piston and the tensioner body when pressure builds in the hydraulic pressure chamber, wherein metallic bands or seals are placed over a hydraulic tensioner piston in order to seal the high pressure chamber and prevent or reduce leakage through the clearance between the piston and the tensioner body.

### BACKGROUND OF THE INVENTION

### Field of the Invention

The invention pertains to the field of hydraulic tensioners. More particularly, the invention pertains to metallic seals for pistons.

### Description of Related Art

A leakage gap exists between the piston and the tensioner body of hydraulic tensioners.

### SUMMARY OF THE INVENTION

A metallic band that is either spiral or circularly wound is placed over a hydraulic tensioner piston in order to seal the hydraulic pressure chamber and prevent or reduce leakage through a clearance between the piston and the tensioner body.

In one embodiment, a hydraulic tensioner includes a tensioner body having a bore in fluid communication with a source of pressurized fluid through an inlet, a hollow piston slidably received within the bore and having an outer diameter, a hydraulic pressure chamber defined by the hollow piston and the bore of the tensioner body, a piston spring received within the hydraulic pressure chamber for biasing the piston away from the inlet, and a metallic band surrounding the outer diameter of the piston. The metallic band forms a seal between an outer surface of the piston and the tensioner body when pressure builds in the hydraulic pressure chamber.

In another embodiment, a pressure activated metallic seal for a hydraulic tensioner including a tensioner body having a bore in fluid communication with a source of pressurized fluid through an inlet, a hollow piston slidably received within the bore and having an outer diameter, a hydraulic pressure chamber defined by the hollow piston and the bore of the tensioner body, and a piston spring received within the hydraulic pressure chamber for biasing the piston away from the inlet, comprises a metallic band shaped to fit around an outer diameter of the piston.

In another embodiment, a method of reducing leakage between a piston and a tensioner body in a hydraulic tensioner comprising a tensioner body having a bore in fluid communication with a source of pressurized fluid through an inlet, a hollow piston slidably received within the bore and having an outer diameter, a hydraulic pressure chamber defined by the hollow piston and the bore of the tensioner body, a piston spring received within the hydraulic pressure chamber for biasing the piston away from the inlet, and a metallic band surrounding the outer diameter of the piston, comprises the step of activating the band to create a seal between the piston and the tensioner body such that the seal reduces leakage of oil from the hydraulic pressure chamber.

### BRIEF DESCRIPTION OF THE DRAWINGS

FIG. 1 shows a first embodiment of a metallic band.

FIG. 2A shows a piston with the metallic band in an unactivated state.

FIG. 2B shows a side close up view of the piston and metallic band of FIG. 2A.

FIG. 2C shows another close up view of the piston and metallic band of FIG. 2A.

FIG. 3A shows a cross-sectional view of a tensioner with a metallic band in an unactivated state.

FIG. 3B shows a close-up view of the metallic band of FIG. 3A in the tensioner.

FIG. 4A shows a piston with the metallic band in an activated state.

FIG. 4B shows a side close up view of the piston and metallic band of FIG. 4A.

FIG. 4C shows another close up view of the piston and metallic band of FIG. 4A.

FIG. 5A shows a cross-sectional view of a tensioner with a metallic band in an activated state.

FIG. 5B shows a close-up view of the metallic band of FIG. 5A in the tensioner.

FIG. 6 shows a second embodiment of a metallic band.

FIG. 7A shows a piston with the metallic band in an unactivated state.

FIG. 7B shows a side close up view of the piston and metallic band of FIG. 7A.

FIG. 7C shows another close up view of the piston and metallic band of FIG. 7A.

FIG. 8A shows a cross-sectional view of a tensioner with a metallic band in an unactivated state.

FIG. 8B shows a close-up view of the metallic band of FIG. 8A in the tensioner.

FIG. 9A shows a piston with the metallic band in an activated state.

FIG. 9B shows a side close up view of the piston and metallic band of FIG. 9A.

FIG. 9C shows another close up view of the piston and metallic band of FIG. 9A.

FIG. 10A shows a cross-sectional view of a tensioner with a metallic band in an activated state.

FIG. 10B shows a close-up view of the metallic band of FIG. 10A in the tensioner.

FIG. 11 shows a third embodiment of a metallic band.

FIG. 12A shows a piston with the metallic band in an unactivated state.

FIG. 12B shows a side close up view of the piston and metallic band of FIG. 12A.

FIG. 12C shows another close up view of the piston and metallic band of FIG. 12A.

FIG. 13A shows a cross-sectional view of a tensioner with a metallic band in an unactivated state.

FIG. 13B shows a close-up view of the metallic band of FIG. 13A in the tensioner.

FIG. 14A shows a piston with the metallic band in an activated state.

FIG. 14B shows a side close up view of the piston and metallic band of FIG. 14A.

FIG. 14C shows another close up view of the piston and metallic band of FIG. 14A.

FIG. 15A shows a cross-sectional view of a tensioner with a metallic band in an activated state.

FIG. 15B shows a close-up view of the metallic band of FIG. 15A in the tensioner.

### DETAILED DESCRIPTION OF THE INVENTION

Metallic bands or seals are placed over a hydraulic tensioner piston in order to seal the high pressure chamber and prevent or reduce leakage through a clearance between the piston and the tensioner body. The bands are substantially circular in shape to match a shape of an outer diameter of the piston. In addition, the bands are preferably either spiral or circularly wound. The terms “band” and “seal” are used interchangeably herein to identify the metallic piece that is placed around the piston.

The bands or seals are made of metal or another material with an adequately large cross-sectional geometry and material characteristics that meet the durability requirements of the bands. In some preferred embodiments, the bands are made from spring steel such as 302 stainless steel.

In one embodiment, the band or seal is circularly wound such that the two ends of the material can come into contact when the band is in its unactivated, free state. The cross section of the band has a bend such that one edge rises above the other. The inner diameter of the seal is expanded in order to install it onto the piston, thus providing a small clamping load to the piston surface in order to constrain its position during piston extension. During piston retraction, pressure builds in the high pressure chamber and thus gathers under the angled portion of the seal, biasing the seal outward until the seal contacts the tensioner body and seals the high pressure chamber. The piston is preferably designed such that the bottommost portion of the piston has a smaller outside diameter than the portion that resides above the seal cavity to allow for greater oil flow to activate the seal.

In addition, the angle at the bottom of the seal cavity is preferably less than that of the seal itself, creating a cavity under the band in which high pressure oil can act.

In other embodiments, the bands are spiral wound such that the material of the band overlaps itself to some degree, which increases the expansion stiffness of the band. By varying the amount of overlap in spiral wound bands, the band can be tuned to expand at a certain rate or initial expansion pressure. The amount of overlap may be adjusted depending upon the requirements of the timing system application in which the bands are being used. In addition, a spiral wound shape eliminates the small leakage path that may be formed in embodiments using circular wound bands when the band is expanded to fit around the piston.

In one embodiment, a spiral wound band with a straight cross section is installed on the piston with a loose fit. The loose fit of the band allows a cavity to be formed underneath the seal in which high pressure oil can collect to bias the band outward and block the flow of oil between the piston and the tensioner body. The piston is designed such that the bottommost portion has a smaller outside diameter than the portion that resides above the seal cavity to allow for greater oil flow to activate the seal.

In another embodiment, a spiral wound band with a straight cross section is installed on the piston with a tight fit. The fit of the band is such that its outside diameter is smaller than an outside diameter of the piston during piston extension and when the piston retracts, oil pressure from the high pressure chamber acts on the inside diameter of the band via holes drilled in the piston perpendicular to its central axis. This high pressure causes the band to expand and form a seal which blocks oil from leaking out of the high pressure chamber.

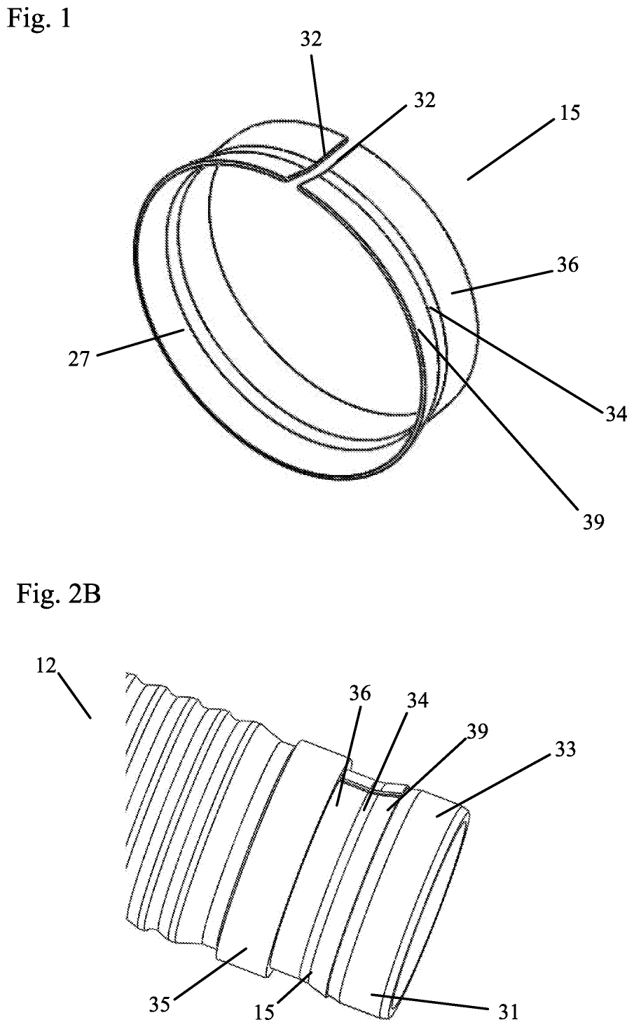

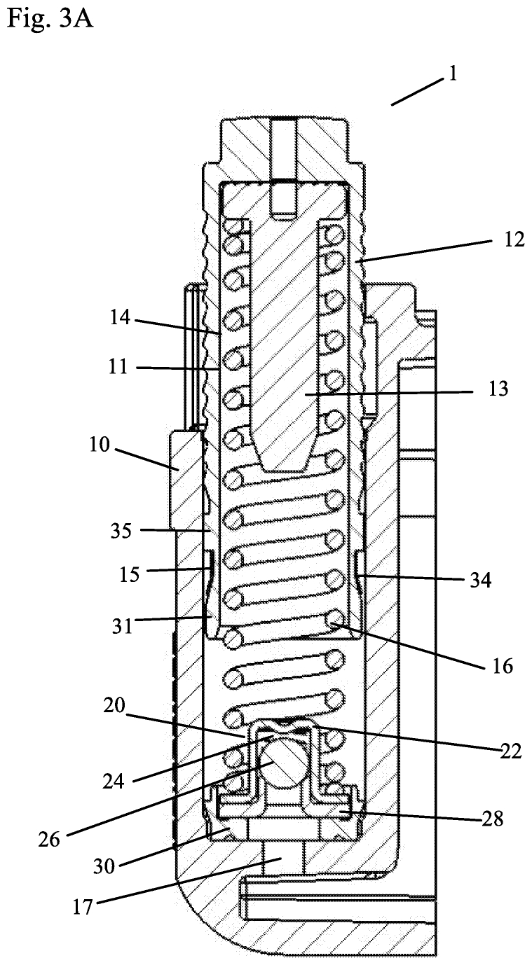

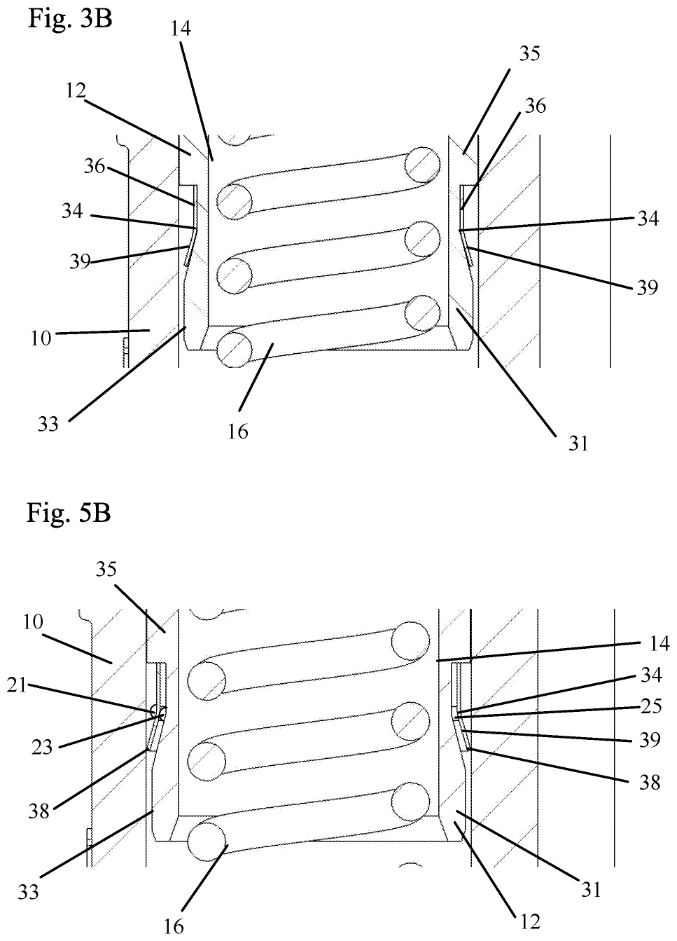

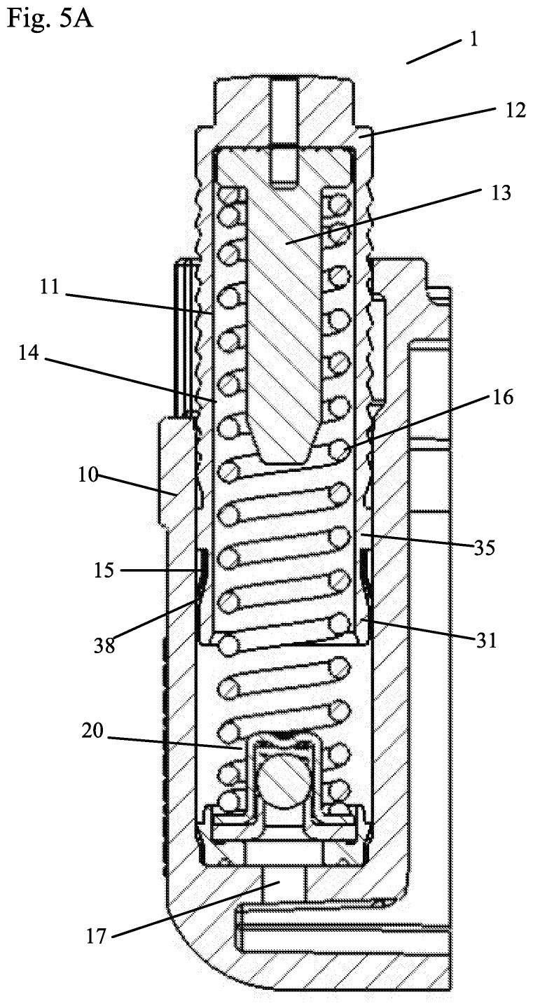

FIGS. 1-5B show a first embodiment of a tensioner 1 with a metallic band, which is a bent seal 15 in this embodiment. The tensioner 1 includes a tensioner body 10, a piston 12, a vent disk 13 (to reduce volume of the tensioner), a hydraulic pressure chamber 14, a check valve assembly 20, a piston seal 15, and a spring 16. The tensioner body 10 defines a cylindrical bore 11 for slidably receiving the hollow piston 12. One end of the bore 11 contains an inlet 17 in fluid communication with an external supply of pressurized fluid (not shown). The hydraulic pressure chamber 14 is defined by an inner circumference of the hollow piston 12, bore 11, compression spring 16 and the check valve assembly 20. The compression spring 16 biases the piston 12 away from the inlet 17. The check valve assembly 20 is located at the base of the piston bore 11 to allow hydraulic fluid to fill the space in the piston bore 11. Although any check valve assembly known in the art could be used, the check valve assembly 20 in the figures includes a retainer 22, a spring 24, a ball 26, a seat 28, and a seal 30.

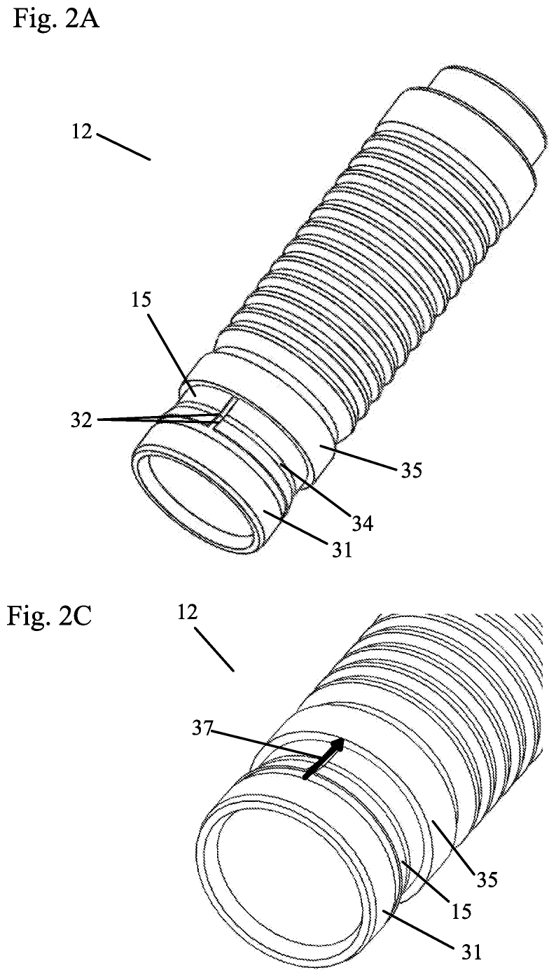

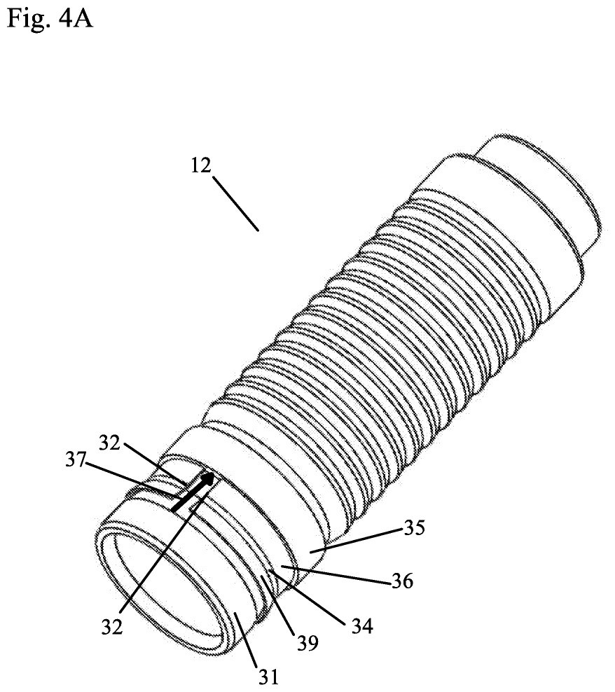

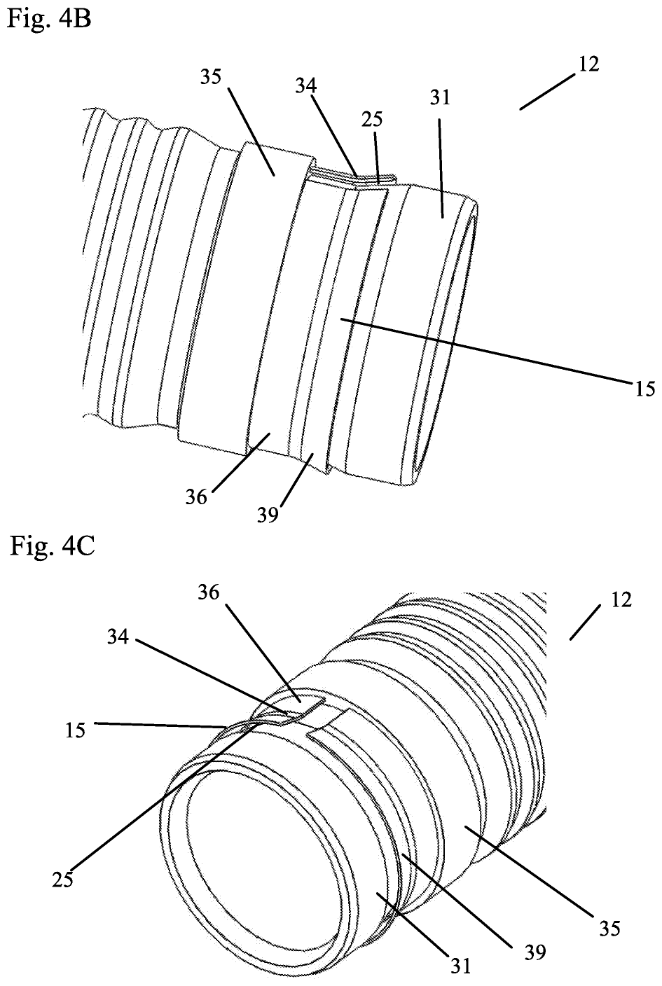

The piston seal 15 is circularly wound such that the two ends 32 of the material can come into contact when the band 15 is in its free state and the cross section of the material has a bend or angle 34 such that one side 36 rises above the other angled portion 39. The inner diameter 27 of the seal is expanded in order to install it onto the piston 12, thus providing a small clamping load to the piston surface in order to constrain its position during piston extension. During piston retraction, pressure builds in the hydraulic pressure chamber 14 and thus acts under the angled portion 39 of the seal, biasing it outward until it contacts 38 the tensioner body 10 and seals the hydraulic pressure chamber 14. The piston 12 is designed such that the bottommost portion 31 has a smaller outer diameter 33 than the portion 35 that resides above the seal cavity 25 to allow for greater oil flow to activate the seal. In addition, the angle 23 at the bottom of the seal cavity 25 is less than the angle 21 of the seal 15 itself, creating the cavity 25 under the band 15 in which high pressure oil can act. A small leakage path 37 (see FIGS. 2C and 4A) may form when the band 15 is expanded to fit around the piston 12.

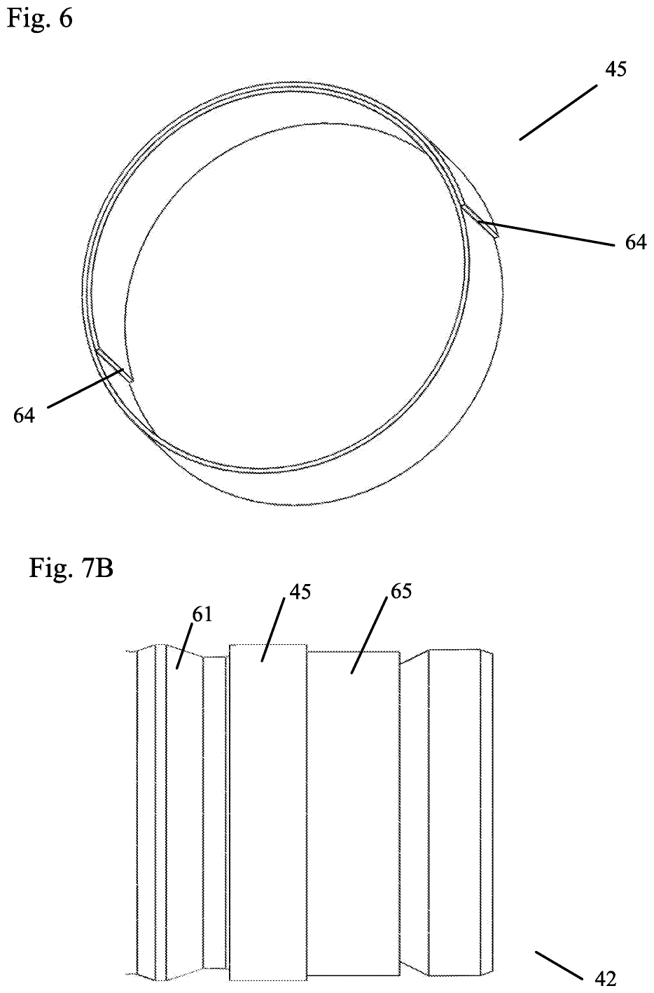

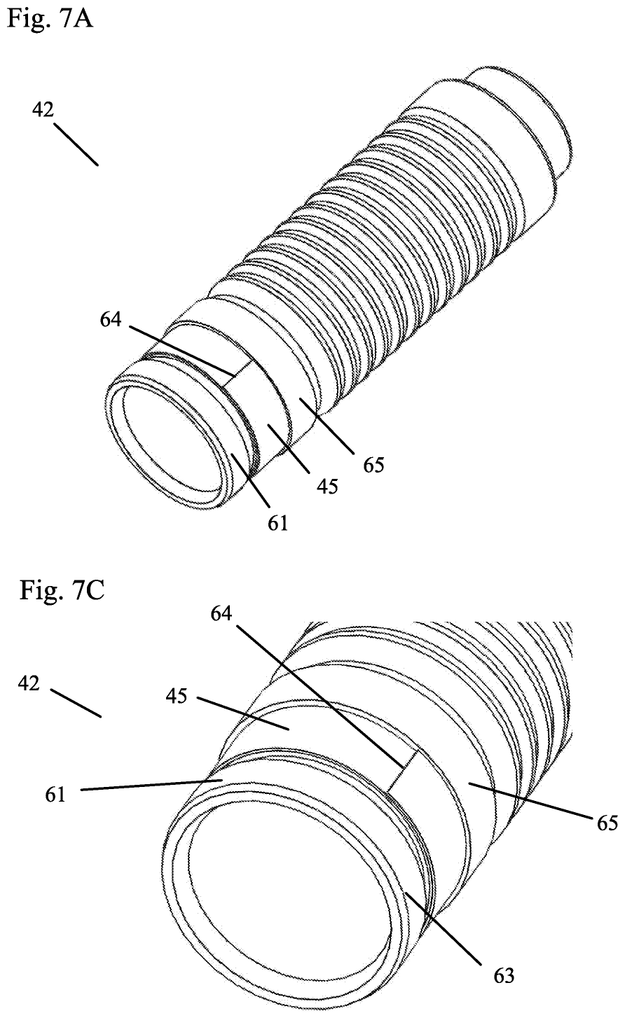

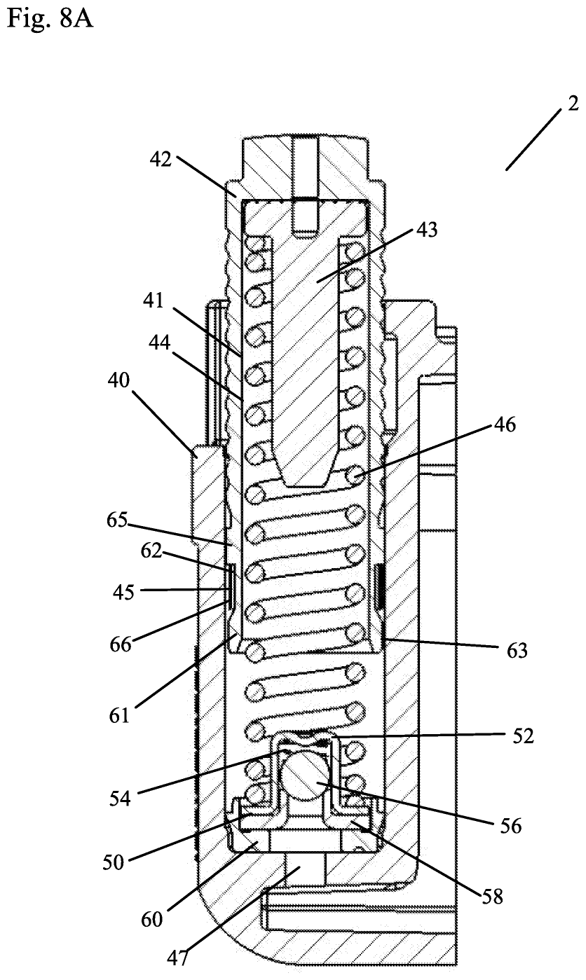

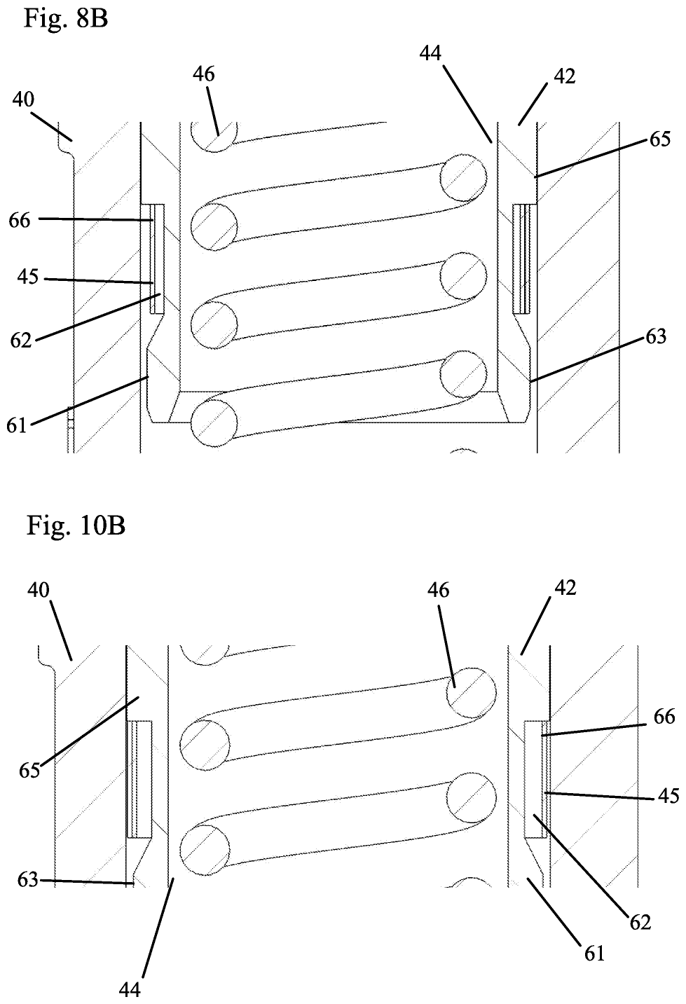

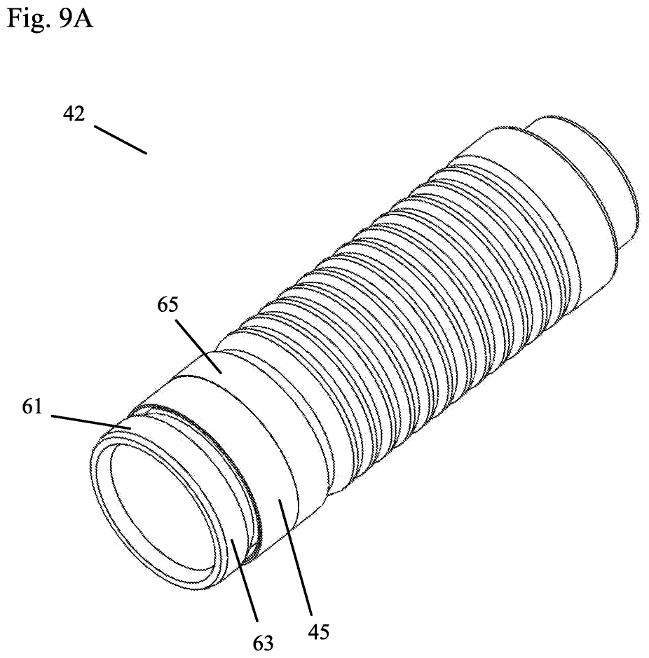

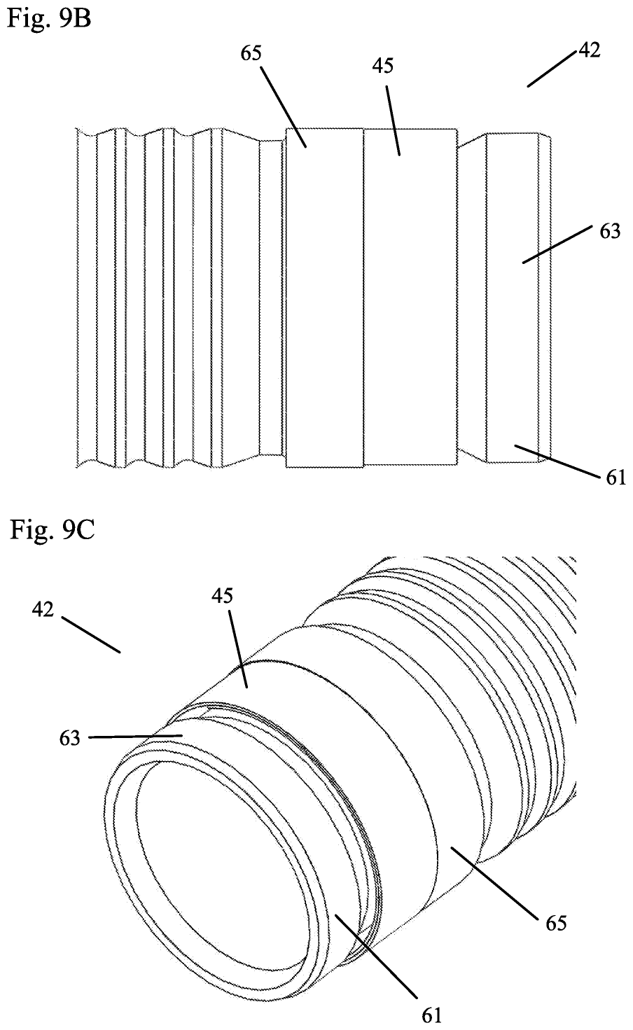

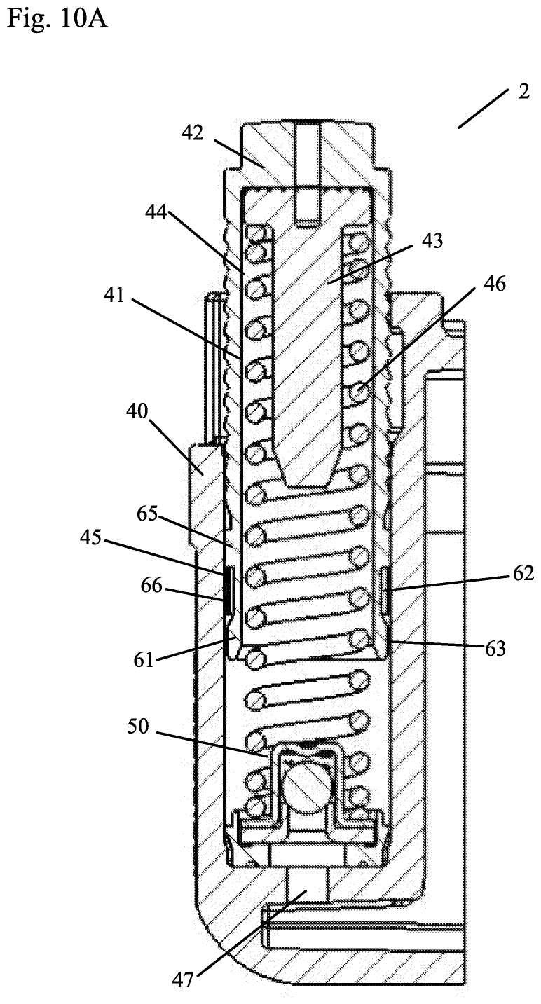

FIGS. 6-10B show a second embodiment of a tensioner 2 with a metallic band, which is a flat floating seal 45 in this embodiment. The tensioner 2 includes a tensioner body 40, a piston 42, a vent disk 43 (to reduce volume of the tensioner), a hydraulic pressure chamber 44, a check valve assembly 50, a piston seal 45, and a spring 46. The tensioner body 40 defines a cylindrical bore 41 for slidably receiving the hollow piston 42. One end of the bore 41 contains an inlet 47 in fluid communication with an external supply of pressurized fluid (not shown). The hydraulic pressure chamber 44 is defined by an inner circumference of the hollow piston 42, bore 41, compression spring 46 and the check valve assembly 50. The compression spring 46 biases the piston 42 away from the inlet 47. The check valve assembly 50 is located at the base of the piston bore 41 to allow hydraulic fluid to fill the space in the piston bore 41. Although any check valve assembly known in the art could be used, the check valve assembly 50 in the figures includes a retainer 52, a spring 54, a ball 56, a seat 58, and a seal 60.

In this embodiment, the piston seal, a spiral wound band 45 with a straight cross section 66, is installed on the piston 42 with a loose fit. The loose fit of the band 45 allows a cavity 62 to be formed underneath the seal 45 in which high pressure oil can collect to bias the band 45 outward and block the flow of oil between the piston 42 and the tensioner body 40. The ends 64 of the band 45 preferably overlap (see FIG. 6), which increases the expansion stiffness of the band 45. By varying the amount of overlap in the spiral condition, the band 45 can be tuned to expand at a certain rate or initial expansion pressure. The piston 42 is designed such that the bottommost portion 61 has a smaller outer diameter 63 than the portion 65 that resides above the seal cavity 62 to allow for greater oil flow to activate the seal 45.

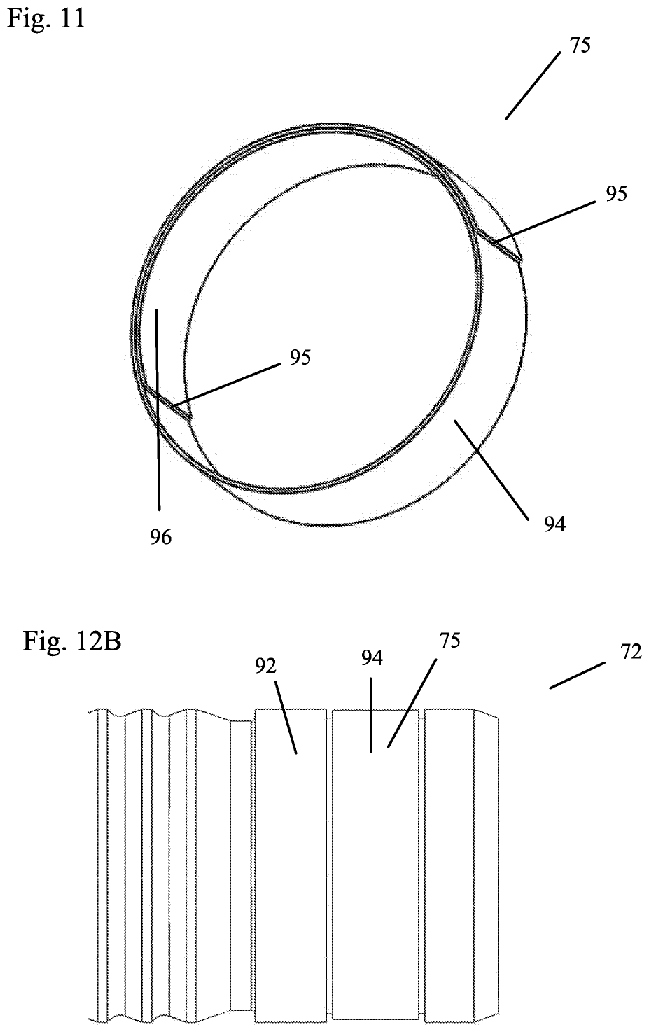

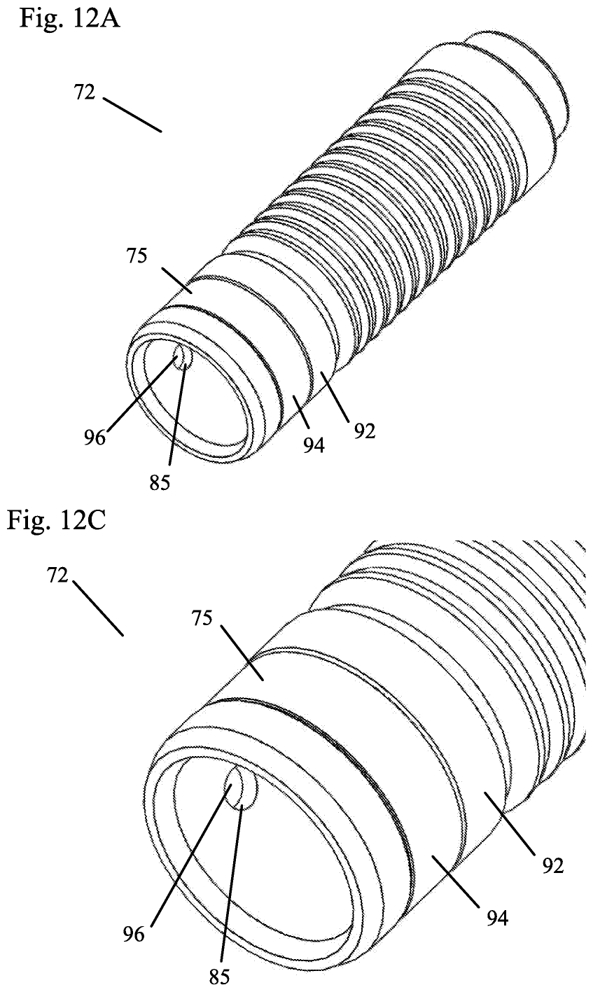

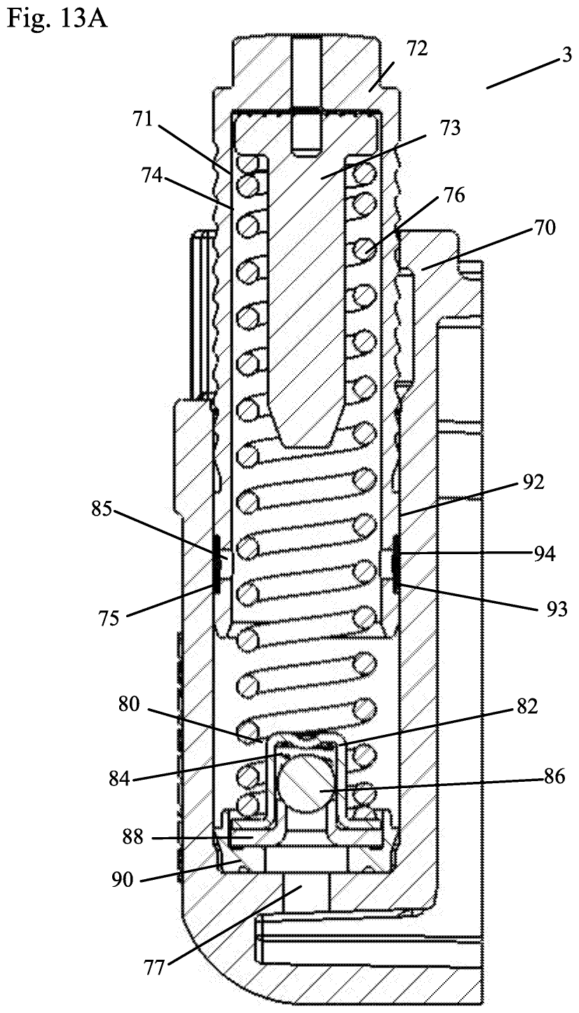

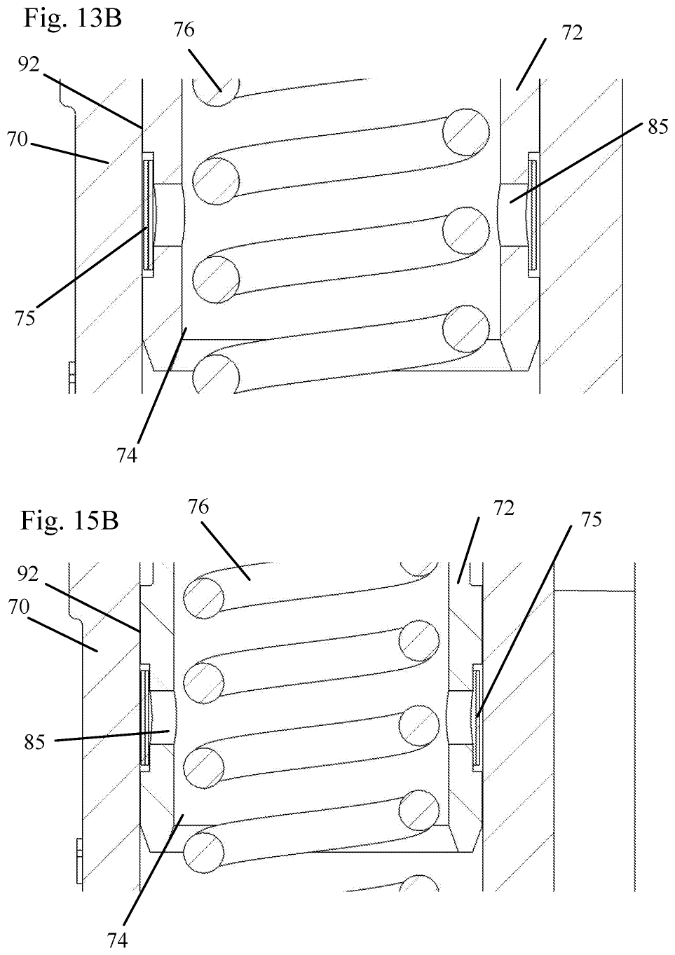

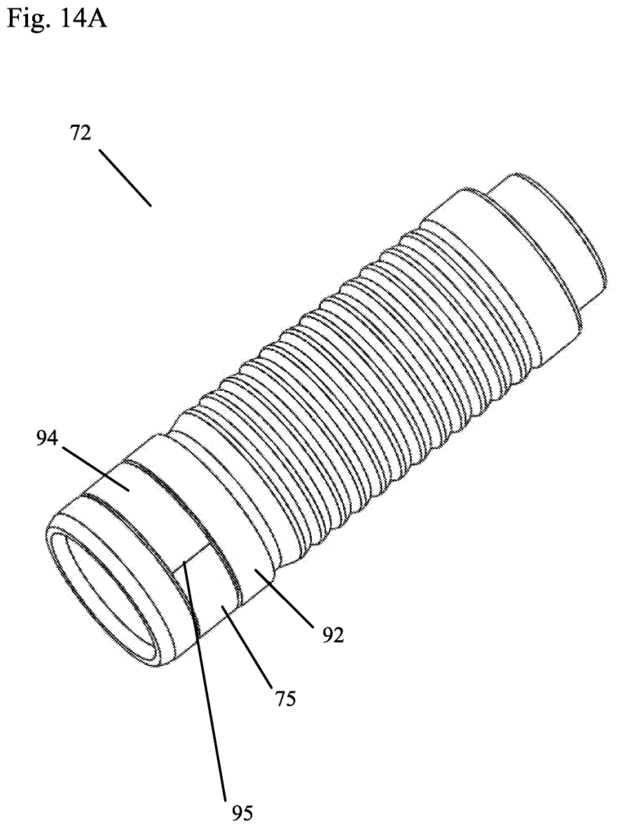

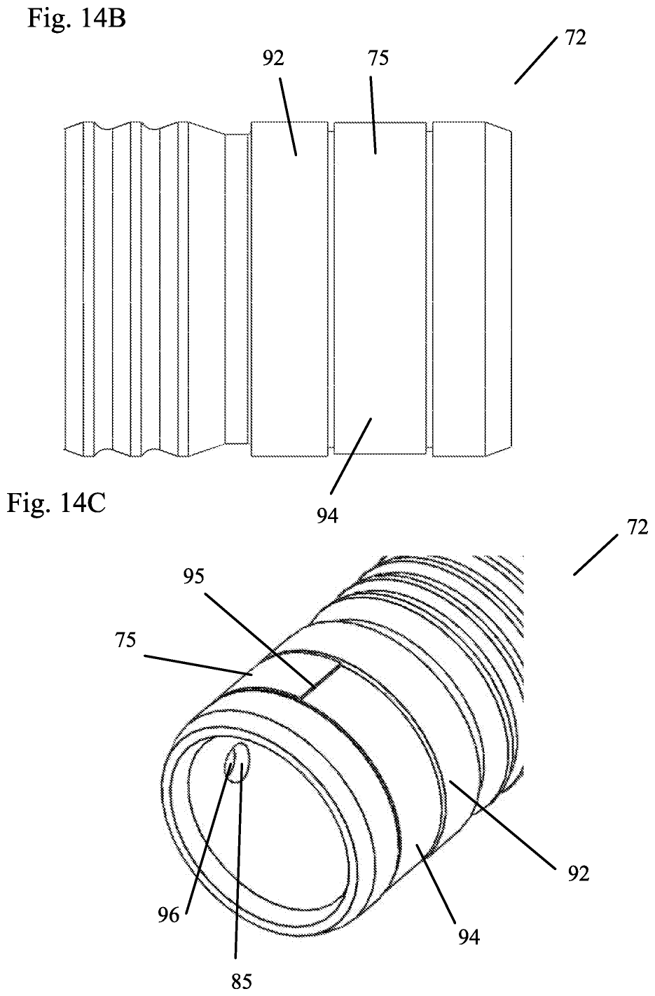

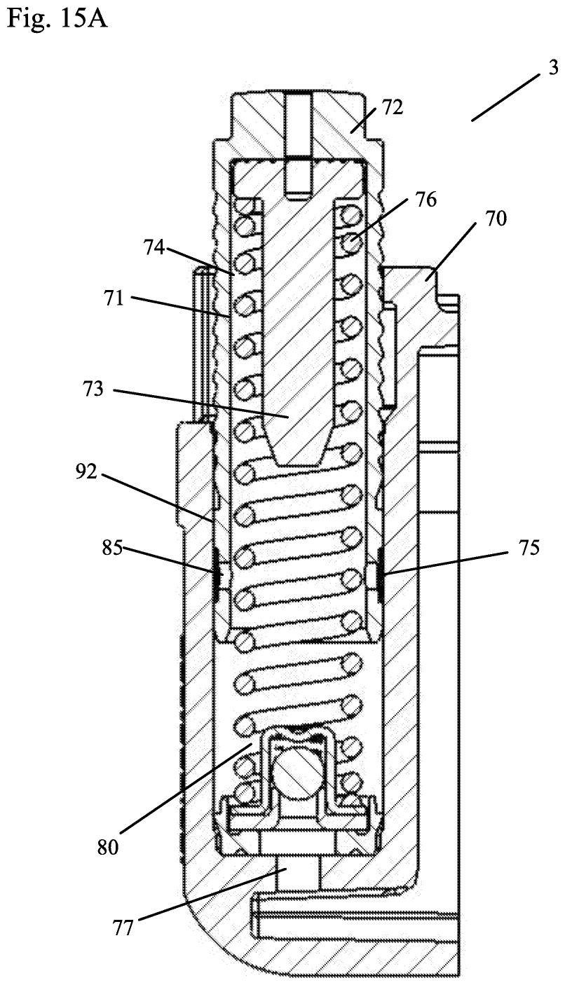

FIGS. 11-15B show a third embodiment of a tensioner 3 with a metallic band, which is a flat seal 75 in this embodiment. The band 75 in FIGS. 11-15B is similar to the band 45 in FIGS. 6-10B, however, the band 75 in FIGS. 11-15B is sized to be tightly fit around the piston 72, while the band 45 in FIGS. 6-10B is sized to be loosely fit around the piston. As a result, the pressure acts on the bands in FIGS. 11-15B differently than the bands in FIGS. 6-10B. In FIGS. 6-10B, there is a cavity formed between the band and the piston surface and, in FIGS. 11-15B, cross holes create a path for high pressure oil to act directly on the underside of the band.

The tensioner 3 includes a tensioner body 70, a piston 72, a vent disk 73 (to reduce volume of the tensioner), a hydraulic pressure chamber 74, a check valve assembly 80, a piston seal 75, and a spring 76. The tensioner body 70 defines a cylindrical bore 71 for slidably receiving the hollow piston 72. One end of the bore 71 contains an inlet 77 in fluid communication with an external supply of pressurized fluid (not shown). The hydraulic pressure chamber 74 is defined by an inner circumference of the hollow piston 72, bore 71, compression spring 76 and the check valve assembly 80. The compression spring 76 biases the piston 72 away from the inlet 77. The check valve assembly 80 is located at the base of the piston bore 71 to allow hydraulic fluid to fill the space in the piston bore 71. Although any check valve assembly known in the art could be used, the check valve assembly 80 in the figures includes a retainer 82, a spring 84, a ball 86, a seat 88, and a seal 90.

In this embodiment, the seal 75, a spiral wound band with a straight cross section 93, is installed on the piston 72 with a tight fit. The fit of the band is such that its outer diameter 94 is smaller than the outer diameter 92 of the piston 72 during piston extension. When the piston 72 retracts, oil pressure from the high pressure chamber 74 acts on the inside diameter 96 of the band 75 via holes 85 in the piston 72 perpendicular to its central axis. In some preferred embodiments, the holes 85 are drilled into the piston 72. The high pressure causes the band 75 to expand and form a seal which blocks oil from leaking out of the hydraulic pressure chamber 74. The band 75 expands to touch the tensioner body 70 and create a seal. Because the gap between the piston 72 and tensioner bore is smaller than the material thickness of the band 75, the band 75 blocks the flow of oil. The ends 95 of the band 75 preferably overlap (see FIG. 11), which increases the expansion stiffness of the band 65. By varying the amount of overlap in the spiral condition, the band 65 can be tuned to expand at a certain rate or initial expansion pressure.

The spiral wound bands 45, 75 eliminate the small leakage path 37 (see FIGS. 2C and 4A) that may be formed in embodiments using circular wound bands 15 when the band 15 is expanded to fit around the piston 12. In embodiments with spiral bound bands, the material preferably overlaps itself (see FIGS. 6 and 11) to some degree, which increases the expansion stiffness of the band. By varying the amount of overlap in the spiral condition, the band can be tuned to expand at a certain rate or initial expansion pressure.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A hydraulic tensioner, comprising:
a tensioner body having a bore in fluid communication with a source of pressurized fluid through an inlet;
a hollow piston slidably received within the bore and having an outer diameter;
a hydraulic pressure chamber defined by the hollow piston and the bore of the tensioner body;
a piston spring received within the hydraulic pressure chamber for biasing the piston away from the inlet; and
a metallic band surrounding the outer diameter of the piston, wherein the metallic band forms a seal between an outer surface of the piston and the tensioner body when pressure builds in the hydraulic pressure chamber.

2. The hydraulic tensioner of claim 1, wherein the seal is formed when hydraulic pressure in the hydraulic pressure chamber biases the seal toward the tensioner body such that the seal reduces leakage from a clearance gap between the tensioner body and the piston.

3. The hydraulic tensioner of claim 1, wherein the band is circularly wound.

4. The hydraulic tensioner of claim 3, wherein the band has an angled cross-section.

5. The hydraulic tensioner of claim 1, wherein an end of the piston adjacent a portion of the piston that the band surrounds has a smaller outer diameter than a portion of the piston on an opposite side of the portion of the piston that the band surrounds.

6. The hydraulic tensioner of claim 1, wherein the band is spiral wound.

7. The hydraulic tensioner of claim 6, wherein the band has a straight cross-section.

8. The hydraulic tensioner of claim 6, wherein the band has a first end and a second end, and the first end and the second end overlap.

9. The hydraulic tensioner of claim 1, wherein the piston has at least one hole drilled perpendicular to a central axis of the piston and the metallic band covers the at least one hole when the metallic band surrounds the outer diameter of the piston.

10. The hydraulic tensioner of claim 1, wherein an inside diameter of the band and the outer diameter of the piston form a cavity.

11. The hydraulic tensioner of claim 1, wherein an outer diameter of the band is smaller than the outer diameter of the piston during piston extension.

12. A pressure activated metallic seal for a hydraulic tensioner comprising a tensioner body having a bore in fluid communication with a source of pressurized fluid through an inlet, a hollow piston slidably received within the bore and having an outer diameter, a hydraulic pressure chamber defined by the hollow piston and the bore of the tensioner body, and a piston spring received within the hydraulic pressure chamber for biasing the piston away from the inlet, comprising:
a metallic band shaped to fit around an outer diameter of the piston.

13. The pressure activated metallic seal of claim 12, wherein the band is circularly wound and has an angled cross-section.

14. The pressure activated metallic seal of claim 12, wherein the band is spiral wound and has a straight cross-section.

15. A method of reducing leakage between a piston and a tensioner body in a hydraulic tensioner comprising a tensioner body having a bore in fluid communication with a source of pressurized fluid through an inlet, a hollow piston slidably received within the bore and having an outer diameter, a hydraulic pressure chamber defined by the hollow piston and the bore of the tensioner body, a piston spring received within the hydraulic pressure chamber for biasing the piston away from the inlet, and a metallic band surrounding the outer diameter of the piston, comprising the step of activating the band to create a seal between the piston and the tensioner body such that the seal reduces leakage of oil from the hydraulic pressure chamber.

16. The method of claim 15, wherein the step of activating the band comprises the substep of biasing the band toward the tensioner body, wherein hydraulic pressure in the hydraulic pressure chamber biases the band toward the tensioner body to create a seal that reduces leakage from a clearance gap between the tensioner body and the piston.
